(19) United States
(12) Patent Application Publication
(10) Pub. No.: US 2014/0375532 A1
(43) Pub. Date: Dec. 25, 2014

(54) Multiple Display-Units LED Light Device has Special Light Effects

(71) Applicant: Tseng-Lu Chien, Walnut, CA (US)

(72) Inventor: Tseng-Lu Chien, Walnut, CA (US)

(21) Appl. No.: 13/923,721

(22) Filed: Jun. 21, 2013

(51) Int. Cl. G09G 3/32

(52) U.S. Cl. CPC G09G 3/3208
USPC 345/77

(57) ABSTRACT

The Multiple Display-units LED light device has special light effects which means the more than one of display-unit can be assembly into one viewing product install within the base by certain strength or assembly means which has the prong means or other unlimited power source mans to supply the electric signal to the said LEDs to make the eye-catching light effects. The display unit may have the build-in input-end or separated input-end to allow to match the said receptacle means of the base. The base with LED related circuit, prong means and other control means, IC means may disposed into the base or incorporated with sealed-unit to make the light beam to be seen by viewer though the viewing area for dedicated art, word, signal, data, design, motion liquid, 3 dimensional, geometric design, art, digital data, liquid crystal screen, LCD and colored image with color change LEDs for illumination.

This is the Continuation of co-pending filing U.S. Ser. No. 11/527,629 filed on Sep. 27, 2006 which got Allowance on May 24, 2013 which for Interchangeable display unit LED night light.

The current invention The Mutiple Display-units LED light device has special light effects further to apply more than one of the said display-unit and each Display-unit has its own LED or LEDs to make each display-unit to be illuminated and make light show which may selected from group combination for steady-on, chasing, random, fade-in and fade-out, sequential, pair flash or any other LED or light functions available from market place control by IC means, sensor means, remote control means, PIR means, heat means, blue tooth means to turn on the said special light show or effects, function, performance which under predetermined design of the said LED device not limited for plug in Night light, current invention cover all unlimited power source device which means the LED device has unlimited power source which no need to replace energy source for certain period of time which may in the desire combination selected from wall outlet, rechargeable batteries, solar power, wind power, chemical power, water power, biologic power or equivalent power which no need to replace for certain period of time.

Non-portable power source which means the LED light device is not for people to wear or bring on the body because the current invention has big power consumer for plurality of LEDs for light show so the this kind of device with portable power source need to replace the batteries very often for the very expensive thin batteries such as CR 2030 or CR2032. So the current invention do not cover the portable LED light device which us such short life and expensive batteries. The battery for current invention should be over the capacity over the 500 ma and cost is cheap such as Carbon battery, Alkline battery which from size of AAA, AA, Sub C, C, or more larger battery for long life, cheap cost application for desk top, Camping, Garden, Festival, Holiday use. It is more appreciated by Green energy such as solar power, Chemical power, Biologic power, food power, or from the computer power which from USB wires means, AC wire means, transformer, adaptor, invertor menas with proper adaptor, plug, receptacle, socket, receiving means such power deliver means to hook with preferred power source.

The current invention for The Mutiple Display-units LED light device has special light effects has difference than co-pending filing basing on following extra features includint:
1. The Mutiple Display-units LED light device has special light effects has

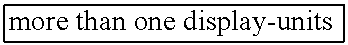

and each display-unit has its own art, design, character, word, logo, sign, geometric shape, color, painting, silkscreen, optics means, light passing through means, semi-transparent means, block-out means, transparent means, plastic resin, Air Bubble, cut outs, opening, windows, colors, characters, cartoon figure, holiday art, seasonal signals, greeting words, commercial advertisement, promotion words, time, digital data display, LCD display screen, Monitor screen, sign or any people understand message on the each display-unit for LED light means to be seen by viewers.
2. The Mutiple Display-units LED light device has special light effects has at least one of the

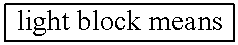

for desire material in preferred shape, construction, design to block out the each LED light beams to interfere or emit into other display-unit to make the light beams in a mess which preferred use metalized sheet. piece, unit in plastic, paper, wooden or other material as long as the LED light beam can not passing though the said block-means to interfere the other display-unit(s) illumination.
3. The Mutiple Display-units LED light device has special light effects has at least one of

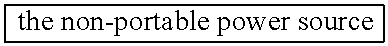

which is not for people to portable to walking because it drain big electric from the batteries, so the current invention for the 1. Plug-in by prong means get the home electricity or 2. The power from the USB port, Computer, Lap top, transformer, adaptor, invertor, charger, USB Charger, solar power, chemical power for any surface installation including desk top, table, wall, floor for indoor or outdoor use. 3. Specially for the Holiday or seasonal or festival for outdoor activities application which can has all art, design, drawing, painting, 3D-engraving, cartoon, character, religion sign, . . . etc. to make the exciting LED light effects, function, performance for color changing, motion, moving message, image, signal to be seen by viewer.
4. The Mutiple Display-units LED light device has special light effects has at least one of the

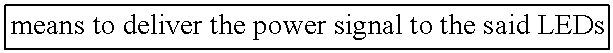

which may selected from group combination such as co-inventor's U.S. Pat. No. 8,303,150 can from the prong means, socket means, AC outlets means, pig-tail wire sets, adaptor plug, plug and receptacle means, socket means, quickly connector means, plug and socket means, USB plug and port means, or any other electric signal delivery means available from market place.
5. The Mutiple Display-units LED light device has special light effects, the said

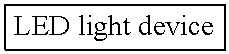

including plug-in night light, table desk LED light, wall mounted LED light, Sign, commercial light box, evacuation sign, advertisement sign, analog time piece, desk top lamp, Clock, light tube, Toy, project light, mobile phone surface panel, communication device, Computer device, consumer electric device as long as these application is not for people portable device and the power can last longer time from the unlimited power source or Energy storage power source or transformer, adaptor, invertor or computer device's USB power all should be fall within the current inventions claims coverage.
6. The Mutiple Display-units LED light device has special light effects has at least one

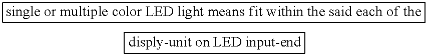

to make the light passing though the said optic-means and show out the art, words, geometric shape, message, data, digital data display, LED display screen, Monitor screen as above listed on (1) to be illuminated to be seen by viewers.
7. The Mutiple Display-units LED light device has special light effects has at least

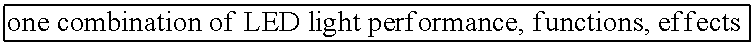

are apply to these said more than one display-units which may selected in desire group from steady-on, flash, sequential, chasing, raondom, fade-in and fade-out, pair flash, desired combination of multiple pair flash to make each of the said display-unit has illumination under pre-determined arrangement.
8. The Mutiple Display-units LED light device has special light effects has at least one

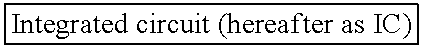

incorporate with the said LED light means to make the light show as above (3) for desire light show not only for each display-unit but also for all display-units has good light show.
9. The Mutiple Display-units LED light device has special light effects has at least one of the

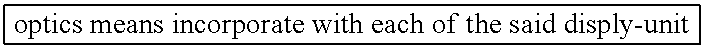

which may selected from light passing though means, light reflective means, light deviation means, retro-reflect means, light refraction means, interface means, convex lens means, concave lens means. forcus means, superposition and interference means, diffraction means, optical resolution means, dispersion means, scattering means, polarization means so can create more eye-catching light effects while apply desired optics means for current inventions.
10. The Mutiple Display-units LED light device has special light effects has at least one of the said

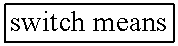

to turn on and off the said LED device which may selected from group combination from sensor means, remote control means, magnetic means, motion sensor means, timer means, heater means, moisture means, flood means, photo sensor means, blue tooth means, sound activate switch, wifi signal, internet signal, transmitter and receiver means.
11. The Mutiple Display-units LED light device has special light effects has at least one

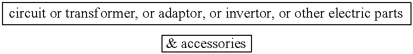

which can change any power source electric signal to work for the said IC means and LED related parts & accessories.
12. The Mutiple Display-units LED light device has special light effects has at least one of the

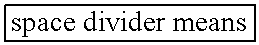

to keep each display-unit's LED has proper space between each other on the horizon or vertical or any axis of the 3 dimensional to make the each display-unit's LED light beams will not interfere or disturb or emit into other display-unit.
13. The Mutiple Display-units LED light device has special light effects, the said

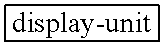

is curve shape, or any geometric shape unit which has 2 or 3 Dimensional with caving, engraving, painting, laser engraving, laser caving to has the 2 or 3 Dimension image can be seen by viewers.
14. The Mutiple Display-units LED light device has special light effects, the said display-units

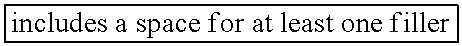

selected from the group consisting of a liquid, chemical compound, miniature objects, floating, stuff, reflective pieces, liquids of different density, a printed background, a screen, and any combination of said fillers.
15. The Mutiple Display-units LED light device has special light effects has at least one of the

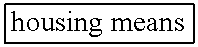

to arrange all the said parts & accessories may selected from group combination of the fasten means, assembly means, catcher means, hold means, fix means, screws means, ultrasonic sealing means, multiple display-units, IC means, switch means, LED related parts & accessories, hosing means, prong means. circuit means, conductive means, prong means, transformer means, adaptor means, socket means, receptacle means, receiving-end, PCB, sensor means, Photo sensor means, remote control means, receiver means, blue tooth means or any other related means to make the said Multiple display-units LED light device has special light effects can work properly put within the said housing.
16. The current invention has very exciting motion or changeable color, changeable message, Moving effects by multiple display-unit(s) to be seen by viewers not like the co-pending filing just the light beams to be seen which not exciting people or kids attention.
1. This current invention as CIP for the U.S. Ser. No. 11/527,629 and the U.S. Ser. No. 11/527,629 are the CIP of below listed CIP application is continuation of
   1. U.S. patent application Ser. No. 10/954,189 “An electro-luminescent (EL) illuminated wall plate device with push-tighten frame means” filed Oct. 1, 2004; and
   2. U.S. patent application Ser. No. 11/094,155 “Multiple function wall cover plate” filed on the Mar. 31, 2005; and
   3. U.S. patent application Ser. No. 11/094,156 “Multiple functions night light” filed on the Mar. 31, 2005; and
   4. U.S. patent application Ser. No. 10/667,787 “Multiple lit-area(s) of Electro-Luminescent element(s) arrangement”; and
   5. U.S. patent application Ser. No. 10/286,871 “A tubular Electro-Luminescent light device”; and
   6. U.S. patent application Ser. No. 10/621,513 “environment proof treatment for Electro-Luminescent (EL) element(s); and
   7. U.S. patent application Ser. No. 11/094,215 “LED night light with liquid arrangement” filed on Mar. 31, 2005 and
   8. U.S. patent application Ser. No. 11/255,981 “Night light with 2 light source” filed on Oct. 24, 2005.
   9. U.S. patent application Ser. No. “Time piece with LED light means, File on Jul. xx, 2006
   10. U.S. patent application Ser. No. “LED light device with Air Fresher”, File on Jul. xx, 2006

### BACKGROUND

This is the Continuation of co-pending filing U.S. Ser. No. 11/527,629 filed on Sep. 27, 2006 which got Allowance on May 24, 2013 which for Interchangeable display unit LED night light.

The current invention The Mutiple Display-units LED light device has special light effects further to apply more than one of the said display-unit and each Display-unit has its own LED or LEDs to make each display-unit to be illuminated and make light show which may selected from group combination for steady-on, chasing, random, fade-in and fade-out, sequential, pair flash or any other LED or light functions available from market place control by IC means, sensor means, remote control means, PIR means, heat means, blue tooth means to turn on the said special light show or effects, function, performance which under predetermined design of the said LED device not limited for plug in Night light, current invention cover all unlimited power source device which means the LED device has unlimited power source which no need to replace energy source for certain period of time which may in the desire combination selected from wall outlet, rechargeable batteries, solar power, wind power, chemical power, water power, biologic power or equivalent power which no need to replace for certain period of time.

Non-portable power source which means the LED light device is not for people to wear or bring on the body because the current invention has big power consumer for plurality of LEDs for light show so the this kind of device with portable power source need to replace the batteries very often for the very expensive thin batteries such as CR 2030 or CR2032. So the current invention do not cover the portable LED light device which us such short life and expensive batteries. The battery for current invention should be over the capacity over the 500 ma and cost is cheap such as Carbon battery, Alkline battery which from size of AAA, AA, Sub C, C, or more larger battery for long life, cheap cost application for desk top, Camping, Garden, Festival, Holiday use. It is more appreciated by Green energy such as solar power, Chemical power, Biologic power, food power, or from the computer power which from USB wires means, AC wire means, transformer, adaptor, invertor menas with proper adaptor, plug, receptacle, socket, receiving means such power deliver means to hook with preferred power source.

The current invention for The Mutiple Display-units LED light device has special light effects has difference than co-pending filing basing on following extra features includint:
1. The Mutiple Display-units LED light device has special light effects has

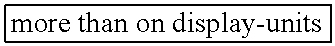

and each display-unit has its own art, design, character, word, logo, sign, geometric shape, color, painting, silkscreen, optics means, light passing through means, semi-transparent means, block-out means, transparent means, plastic resin, Air Bubble, cut outs, opening, windows, colors, characters, cartoon figure, holiday art, seasonal signals, greeting words, commercial advertisement, promotion words, time, digital data display, LCD display screen, Monitor screen, sign or any people understand message on the each display-unit for LED light means to be seen by viewers.
2. The Mutiple Display-units LED light device has special light effects has at least one of the

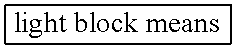

for desire material in preferred shape, construction, design to block out the each LED light beams to interfere or emit into other display-unit to make the light beams in a mess which preferred use metalized sheet. piece, unit in plastic, paper, wooden or other material as long as the LED light beam can not passing though the said block-means to interfere the other display-unit(s) illumination.
3. The Mutiple Display-units LED light device has special light effects has at least one of

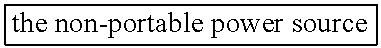

which is not for people to portable to walking because it drain big electric from the batteries, so the current invention for the 1. Plug-in by prong means get the home electricity or 2. The power from the USB port, Computer, Lap top, transformer, adaptor, invertor, charger, USB Charger, solar power, chemical power for any surface installation including desk top, table, wall, floor for indoor or outdoor use. 3. Specially for the Holiday or seasonal or festival for outdoor activities application which can has all art, design, drawing, painting, 3D-engraving, cartoon, character, religion sign, . . . etc. to make the exciting LED light effects, function, performance for color changing, motion, moving message, image, signal to be seen by viewer.
4. The Mutiple Display-units LED light device has special light effects has at least one of the

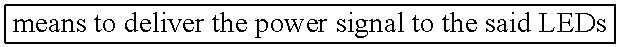

which may selected from group combination such as co-inventor's U.S. Pat. No. 8,303,150 can from the prong means, socket means, AC outlets means, pig-tail wire sets, adaptor plug, plug and receptacle means, socket means, quickly connector means, plug and socket means, USB plug and port means, or any other electric signal delivery means available from market place.
5. The Mutiple Display-units LED light device has special light effects, the said

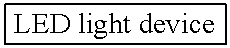

including plug-in night light, table desk LED light, wall mounted LED light, Sign, commercial light box, evacuation sign, advertisement sign, analog time piece, desk top lamp, Clock, light tube, Toy, project light, mobile phone surface panel, communication device, Computer device, consumer electric device as long as these application is not for people portable device and the power can last longer time from the unlimited power source or Energy storage power source or transformer, adaptor, invertor or computer device's USB power all should be fall within the current inventions claims coverage.
6. The Mutiple Display-units LED light device has special light effects has at least one

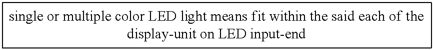

to make the light passing though the said optic-means and show out the art, words, geometric shape, message, data, digital data display, LED display screen, Monitor screen as above listed on (1) to be illuminated to be seen by viewers.
7. The Mutiple Display-units LED light device has special light effects has at least

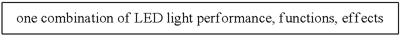

are apply to these said more than one display-units which may selected in desire group from steady-on, flash, sequential, chasing, raondom, fade-in and fade-out, pair flash, desired combination of multiple pair flash to make each of the said display-unit has illumination under pre-determined arrangement.
8. The Mutiple Display-units LED light device has special light effects has at least one

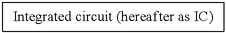

incorporate with the said LED light means to make the light show as above (3) for desire light show not only for each display-unit but also for all display-units has good light show.
9. The Mutiple Display-units LED light device has special light effects has at least one of the

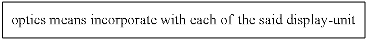

which may selected from light passing though means, light reflective means, light deviation means, retro-reflect means, light refraction means, interface means, convex lens means, concave lens means. forcus means, superposition and interference means, diffraction means, optical resolution means, dispersion means, scattering means, polarization means so can create more eye-catching light effects while apply desired optics means for current inventions.
10. The Mutiple Display-units LED light device has special light effects has at least one of the said

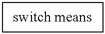

to turn on and turn off the said LED device which may selected from group combination from sensor means, remote control means, magnetic means, motion sensor means, timer means, heater means, moisture means, flood means, photo sensor means, blue tooth means, sound activate switch, wifi signal, internet signal, transmitter and receiver means.
11. The Mutiple Display-units LED light device has special light effects has at least one

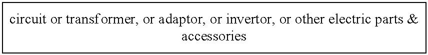

which can change any power source electric signal to work for the said IC means and LED related parts & accessories.
12. The Mutiple Display-units LED light device has special light effects has at least one of the

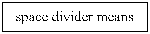

to keep each display-unit's LED has proper space between each other on the horizon or vertical or any axis of the 3 dimensional to make the each display-unit's LED light beams will not interfere or disturb or emit into other display-unit.
13. The Mutiple Display-units LED light device has special light effects, the said

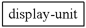

is curve shape, or any geometric shape unit which has 2 or 3 Dimensional with caving, engraving, painting, laser engraving, laser caving to has the 2 or 3 Dimension image can be seen by viewers.
14. The Mutiple Display-units LED light device has special light effects, the said display-units

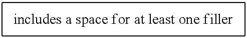

selected from the group consisting of a liquid, chemical compound, miniature objects, floating, stuff, reflective pieces, liquids of different density, a printed background, a screen, and any combination of said fillers.
15. The Mutiple Display-units LED light device has special light effects has at least one of the

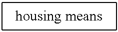

to arrange all the said parts & accessories may selected from group combination of the fasten means, assembly means, catcher means, hold means, fix means, screws means, ultrasonic sealing means, multiple display-units, IC means, switch means, LED related parts & accessories, hosing means, prong means. circuit means, conductive means, prong means, transformer means, adaptor means, socket means, receptacle means, receiving-end, PCB, sensor means, Photo sensor means, remote control means, receiver means, blue tooth means or any other related means to make the said Multiple display-units LED light device has special light effects can work properly put within the said housing.
16. The current invention has very exciting motion or changeable color, changeable message, Moving effects by multiple display-unit(s) to be seen by viewers not like the co-pending filing just the light beams to be seen which not exciting people or kids attention.

Please refer to the prior filing content as below for earlier features v.s. above listed difference of current invention.

The current invention for LED night light with interchangeable display unit disclosure a 1st features to offer a very safety design to prevent people away from expose prong means to get the electric shock. The interchangeable display unit means the display unit can be separated under certain pulling, pushing, twisting, kicking, dropping, or other impact strength so the force applied to the prong means will bid reduced because the display unit already separated from base and torque force because the distance reduce so become the minimum amount and can not harm to the base's prong mean. This will keep the prong means for the most safety under any potential impact strength may apply to the said night light.

The current invention for LED night light with interchangeable display unit disclosure a 2nd features to adapt the sealed-unit which sealed all the components contact with the live wires which have very high voltage under certain frequency which may cause people have very dangerously harm, so the said sealed-unit will make sure all components are sealed within a most safety case away from people to touch these dangerously parts under any condition. I. E. The sealed-unit may seal the LED circuit, prong means, control mean, and related parts may dispose within a qualified material case to become a sealed-unit to meet the required safety standard so all other housing parts can use any material without limitation because the said qualified material is only material touch the live wire.

The current invention for LED night light with interchangeable display unit disclosure a 3rd features to adapt the different display unit which have display area and display input-ends for quickly installation and has the most eye-catching light effects by different display area design may selected from group combination from (1) The said display area has certain treatment may selected from opening(s), cut-out(s), hole(s) on its surface to make the desired light effects and performance. Or (2) The said display area has space to load liquid, chemical compound, miniatures, floating staff, reflective piece, variety density liquid, printing background, screen, or desired combination of listed items within the said space. Or (3) The said display area has curved egg-shell shape with negative or positive grave process applied to make the inner surface with 3 dimensional with sufficient depth to make the design, artwork character, drawing, cartoons look alive.

The current invention for LED night light with interchangeable display unit disclosure a 4^{th} features to disclosure the display unit has the display area and separate display input-end. The said night light base which has at least one of prong means to connect with the power source and one receptacle means to receive the said display input-end. The said LED light means connect with related circuit, control means, and prong means to make the said LED to be turn on under predetermined functions and period of time. The improvement including, The said receptacle means is build-in on the base as one piece which the said receptacle means block out the live wires and components away from people to be touched and match the said display input-end. The said display input-end to connect with the receptacle means to get the light, heat, or desired physical phenomenon from the said base inner electric device. The said display area has geometric shape with space to load liquid, chemical compound, miniatures, floating staff, reflective piece, variety density liquid, printing background, screen, solid plastic resin with geometric air bubble inside, or desired combination of listed items within the said space. This feature will let all the said night light with very safety and splendid light effects.

The current invention for LED night light with interchangeable display unit disclosure a 5^{th} features to disclosure the display unit may be selected from any combination select from liquid filled unit, solid plastic unit with air bubble within, solid plastic unit with laser graving within, curved plastic with 3 dimensional graving art, plastic piece with cut-out(s) or equivalent treatments. The said display area has geometric shape with space to load liquid, chemical compound, miniatures, floating staff, reflective piece, variety density liquid, printing background, screen, solid plastic resin with geometric air bubble inside, or desired combination of listed items within the said space. These design will make the said night light with splendid light effects.

Hereafter has the details drawing and details description to explain the spirit of the current invention as below.

### DRAWING

FIG. 1: Disclosure the 1^{st} embodiment for LED Night light with multiple display-unit(s) which with the display unit may has plurality of art, design, geometric shape, sign, logo, words, message, digital data on each of the said display-unit(s) and illuminated by the said LEDs for the exciting light effects.

FIG. 1-1: Disclosure the said Multiple Display-units LED light device has special light effects which the said multiple display-units are assembly together by alternative method without the receptacle means may selected from group combination selected from screw, hole & pole, catcher, sonic, glue, chemical compound, hooks, rivet or any other fix means, assembly means to make multiple display-units can install within the holder or the said housing means.

FIG. 2-FIG. 4 and FIG. 5-1-5-3 and FIG. 6-6-1: Disclosure the preferable display unit for different embodiment for said the Multiple display-units LED Device has special light effects has LEDs and multiple display-units with arts, windows, painting, screen, optics means, screen, LCD image to show the viewer while the desire LEDs turn on and turn off under predetermined function to show message or data or signal on different display-units including the 2 and 3-dimension display with preferred LEDs, Block means, Space means to prevent from the LEDs light beam to emit into wrong display-units to make interfere of light effects, function, performance.

FIG. 7: Disclosure the other embodiment of said Multiple display-units LED device has special light effects, the said display unit with display-unit with space so can fill up the liquid related items within or further can incorporate with desire heat-element to make the said liquid be moved.

FIG. 8: Disclosure the other embodiment of Multiple display-units LED device has special light effects, the said Multiple display-units are 3 of different diameter cylinder tube for display-unit has its own LED(s) for illuminated under predetermined light function, effects, performance. The Embodiment has Prong means to get home electricity for plug-in type LED device. It also appreciated can has any application as long as non-portable device because portable device can not last long while has many LEDs to make light show The cylinder display-units has tube base with build-in receptacle means to receive the separated display input-end and has plurality of LEDs to position for each display-unit to offer good light show.

FIG. 9: Disclosure the curved and curvel design of the display unit which is not flat surface which belong one of the geometric shape including the 2D or 3Dimensional design still fall within the current invention.

FIG. 10+FIG. 11+FIG. 12+FIG. 13: Disclosure all preferred application for current invention.

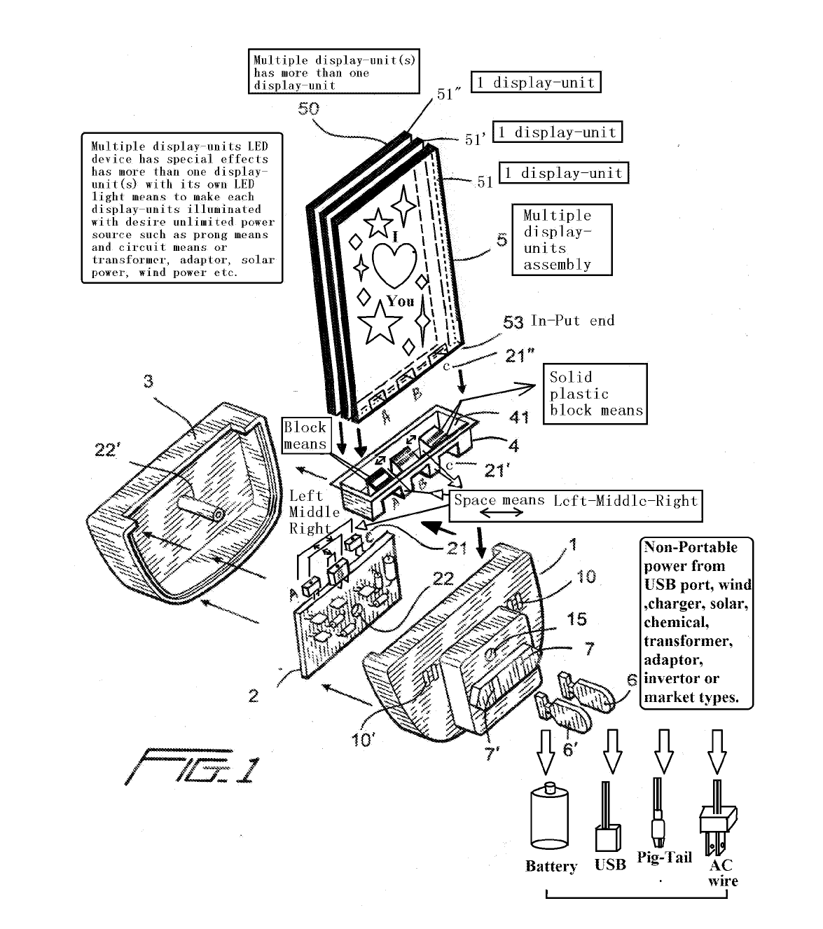

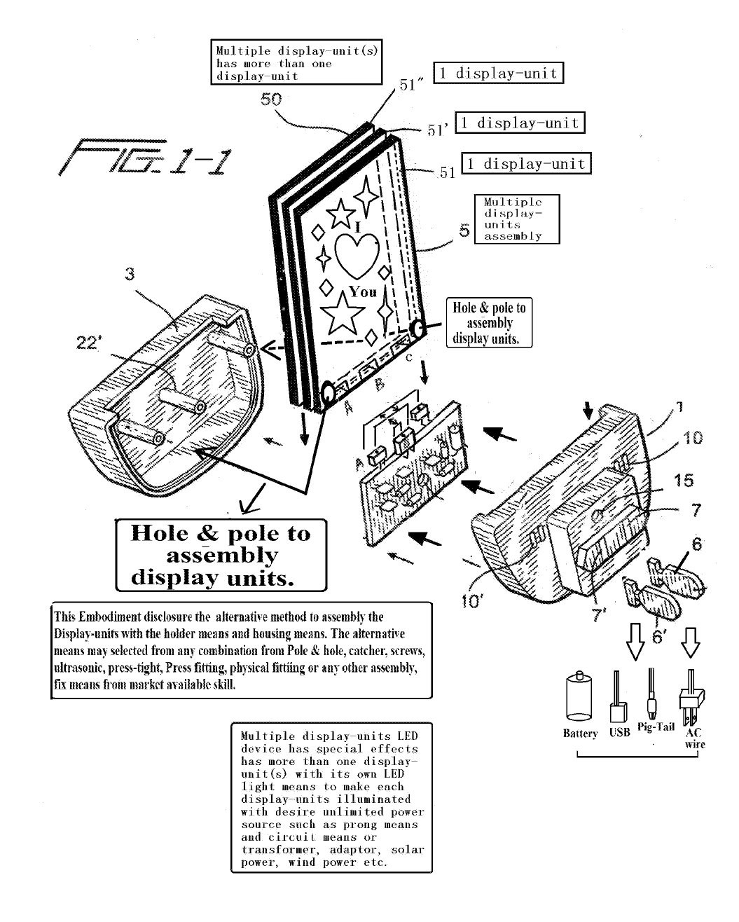

(Prior Arts) FIG. 1+11+12+13+S: Disclosure the co-pending filing U.S. Ser. No. 11/527,629 which filed on Sep. 27, 2006 and got allowance on May 24, 2013 to comparison for current invention drawing which just simple had plurality of display-units and each display-unit has its own LED(s) to make desire colorful, light effects and control by IC and circuit to make the different display-unit(s) has motion for color, image, message, logo, word, screen changeable to get eye-catching purpose to all viewers. Fig S: Disclosure the sealed-unit with LEDs construction to fix on the LED device with details description so this is universal model can fit to all kind of night light device.

### DETAIL DESCRIPTION

The Multiple Display-units LED device has special light effects which has above listed 15 features so can use for the LED device which including

From the co-inventor's prior arts as (Prior Arts) FIG. 1+11+12+13+S: Disclosure the co-pending filing U.S. Ser. No. 11/527,629 which filed on Sep. 27, 2006 and got allowance on May 24, 2013 to comparison for current invention drawing which just simple had plurality of display-units and each display-unit has its own LED(s) to make desire colorful, light effects and control by IC and circuit to make the different display-unit(s) has motion for color, image, message, logo, word, screen changeable to get eye-catching purpose to all viewers. Fig S: Disclosure the sealed-unit with LEDs construction to fix on the LED device with details description so this is universal model can fit to all kind of night light device. →Please review the details parts definition so easiler to understand the current invention for upgrade.

From Fig S, disclosure the sealed-unit (S2) (S12) (S22) with pre-designed opening (S2′) (S12′) (S22′) to allow the universal type of the sealed-unit (S2) (S12) (S22) can fit into the opening (S2′) (S12′) (S22′) which can use the conventional market method to fasten with the base (S1) (S10) (S20) which may assemble with the said night light by screw (S23) (S24), welding, sonic sealing, glue, solvent, rivet, catcher, or equivalent fix-means skill from the convention market to allow the sealed-unit be fix on position. The sealed-unit (S2) (S12) (S22) preferable to use the plastic with certain thickness to pass the 94-V-0 flammable grade to meet the safety standard and all other housing part (S1) (S10) (S20) without any limitation because without touching the live wires. The base (S1) (S10) (S20) can be any shape, configuration, design, curvature, thickness, material, dimension with build-in or separated receptacle means. The sealed-unit has LED related circuit, control means, prong means disposed within, this can design for super slim and wider unit or thicker for small unit which depend on the market requirement. For convenience, It also can make a desired unit which can fit into different base shape such as boat shape (S1), tube shape (S10), Rectangular shape (S20) for different night light application.

The Boat Base (S1) has opening (S2′) to allow the sealed-unit (S2) can fit into the space. The sealed-unit (S2) has the LED related circuit (S8) and its components (S9) and prong means (S7) (S7′) are sealed within the case (S2). The top of the case have two LEDs (S3) (S4) which are connected with the inner circuit (S8) but all the LEDs' electric legs can not be touched by test equipment to make sure the kid finger will not touch these live wires to cause dangerous condition. The LED (S5) can be use the conductive wires (S6) to pull to far away the unit's housing (S2) for other illumination arrangement.

The LEDs (S3) (S4) also fit into the base opening (S3′) (S4′) and a wall (S2″) will cover the LEDs after the assembly with base housing. After the assembly, The LED light beams can be passing though the base's opening area (S) to make the good light effects to the upper display unit.

From the tube base (S10) has the opening (S12′) to allow the sealed-unit (S12) to fit into with two or more LED on desired position and orientation and wiring arrangement so can allow the light beams emit out from the base top opening (S18) and lower window (S18′) for desired illumination.

From the Rectangular base (S20), It is special for the Surface light arrangement. The LED spot light beams though a light-medium (S28) to allow the LED light beam to travel within the light-medium (S28) and majority of light beam to be seen by viewer from light-medium (S28) surface. It will not see any hot spot of LED light brightness but see a very soft and even photometric area light for special illumination. From the Rectangular base (S20) has opening (S22′) to allow the sealed-unit (S22) can be fit into tightly with glue or solvent of other adhesive means, sonic means, welding means, catcher means, or hook means to assembly with rectangular house (S20). The LED will fit into the light-medium's thickness to get the best result.

From FIG. 1, The LED night light with Interchangeable display unit (5) which interchangeable means the said display unit (5) can be separated from the said base (1) under certain pulling, twisting, pushing, or any strength apply to the said night light without any tools needed. The feature of this will reduce the pulling weight apply to top of display unit (5) to make the big torque to apply to the base back area and break to let the prong means (6) (6′) exposure to air and cause people electric shock.

The back base (1) has hole (7) (7′) to allow the prong means (6) (6′) can be passing though and solder with the inner Printing Circuit Board (hereafter as PCB) to deliver the power source to the said PCB (2) and drive the all LED related circuit (variety items on the drawing) to work under pre-determined functions, period time, control means. The PCB has hole (22) which can allow the front base (3) central pole to be passing though and allow the screw (not shown) to be applied to the back base's hole (15) to fasten the two base together and has the PCB(2) and receptacle means (4) within.

The receptacle means (4) have variety openings, cutouts, or equivalent windows to allow the said LEDs (21) can be install on right and respect position (21′) to make the light beams toward t the display input-end (21″) to make the display unit (5) for desired illumination. The same arrangement are applied to the other two LEDs to align with its respect receptacle's openings and toward the LEDs to the display's input-ends. The display unit (5) has the display area (50) (51) for light performance and display input-ends (21″) for get light beams into the display unit (5).

From FIG. 11, The current invention has the special design for the said display area (8E). The display area (8E) which has geometric shape with space to load liquid (8 a), chemical compound (8 a′), miniatures (8 f) (8 g), floating staff (8 s), reflective piece(8 b) (8 c) (8 d) (8 e), variety density liquid (8 a) (8 a′), printing background on back of housing (8W), screen (not shown), solid plastic resin with geometric air bubble inside (not shown), or desired combination of listed items within the said space (as whole image of the 8E). The display unit have a top area which is raised portion (8H) to allow the air-space which can make the moving liquid have proper functions while we apply the heat-element (86) (88) on the display input-ends (86″) (87″) though the receptacle means opening (86′) (87′) which can delivery the heat-element temperature to the display input-ends and cause the display inner chemical to become moving flow and carry all the reflectors to move. This is very nice effects. The LED (87) can offer the different light effects may selected from group combination from steady on, chasing light (While apply the 3 colors LED in 1), random, pair flash, color changing, or any conventional light effects available from market place.

The raised portion (8H) need a cosmetic cover (8F) to allow the raised portion (8H) to fit within the space (8H′) so have nice viewing appearance.

The front (8 c) and back base (8A) are sealed by fasten means or screws as earlier discussion for FIG. 1 by conventional skills.

From FIG. 1, The display unit (5), base (1) (3), or sealed unit (Fig S) material can be select from group combination from wood, pottery, porcelain, metal, bamboo, poly, plastic resin, paper, textile, weaving staff, or conventional material which available from market place.

From FIG. 1, The display area has certain treatment may selected from opening(s), cut-out(s), hole(s) on its surface to make the desired light effects and performance.

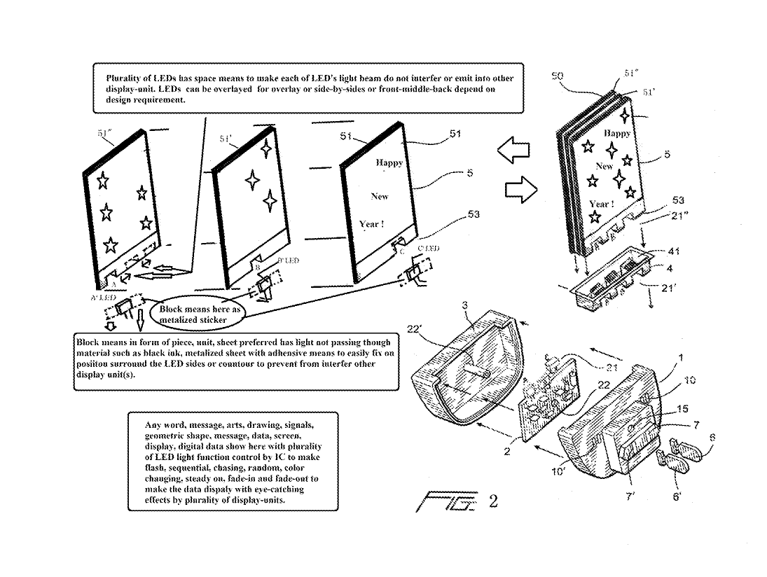

From FIG. 2, disclosure the alternative 9 styles of the preferable display unit with its display area and display input-end for better understanding.

FIG. 2, The display unit (20) has plurality of cutouts areas (21) and 3 display input-ends (22).

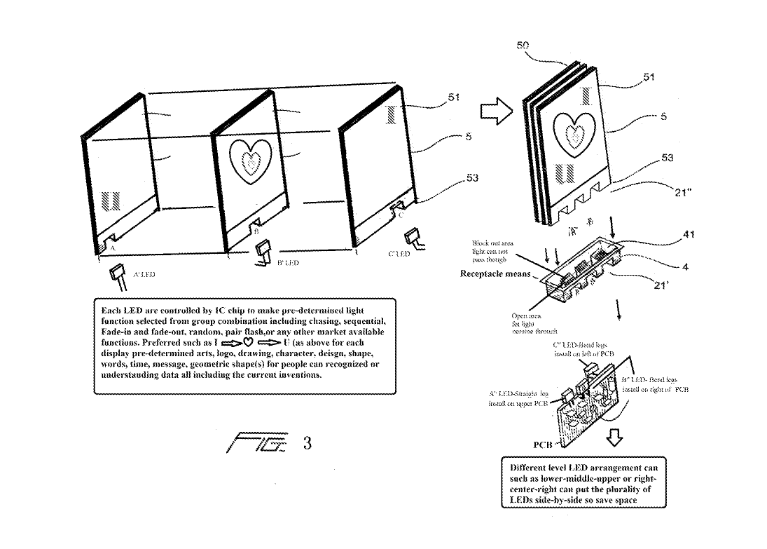

FIG. 3, The display unit (30) has plurality of groove or window areas (31) and 3 display input-ends (32).

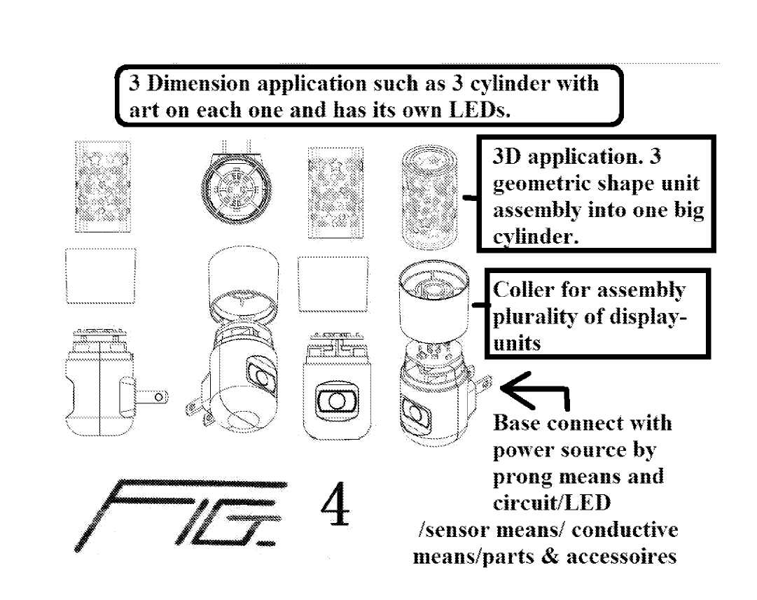

FIG. 4, The display unit (40) has plurality of cutouts or window areas (41) and 4 display input-ends (42).

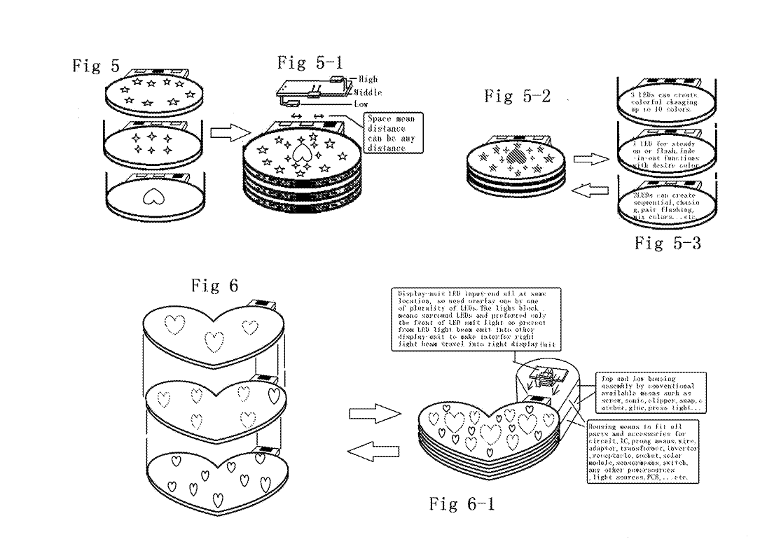

FIG. 5, The display unit (50) has plurality of cutouts areas (51) and 3 display input-ends (52).

FIG. 6, The display unit (60) has plurality of cutouts areas to form the design (61) and 3 display input-ends (62).

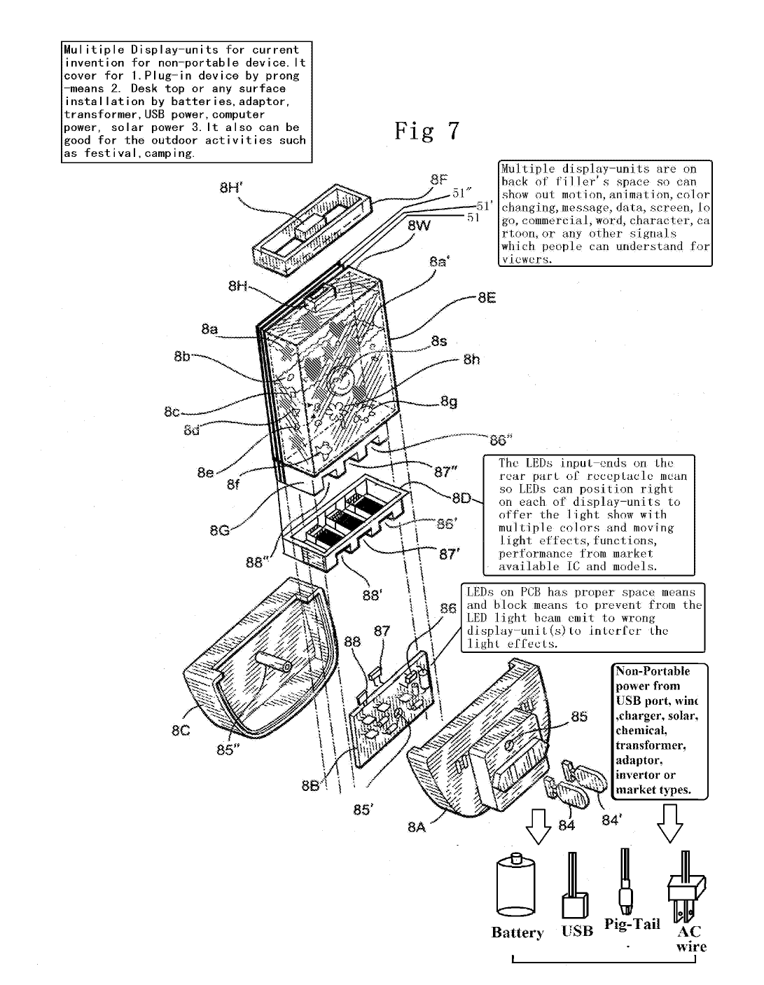

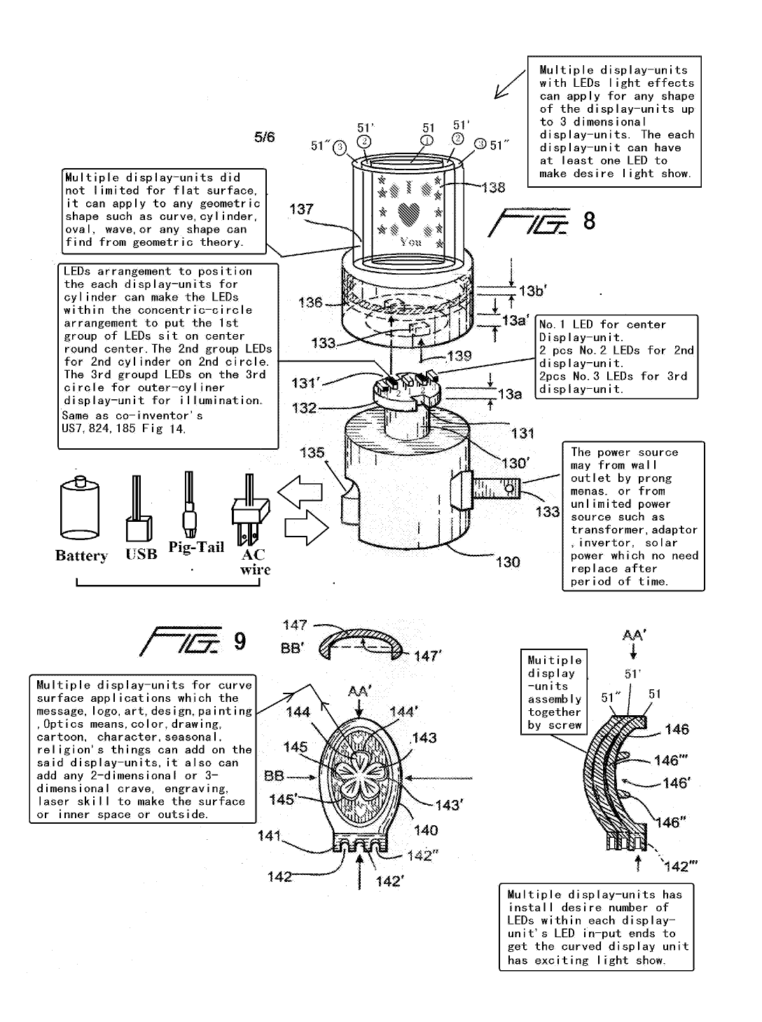

FIG. 7, The display unit (70) has plurality of cutouts areas and window (71) and 3 display input-ends (72).

FIG. 8, The display unit (80) has plurality of cutouts areas (81) to form a tulip flower design and 3 display input-ends (82).

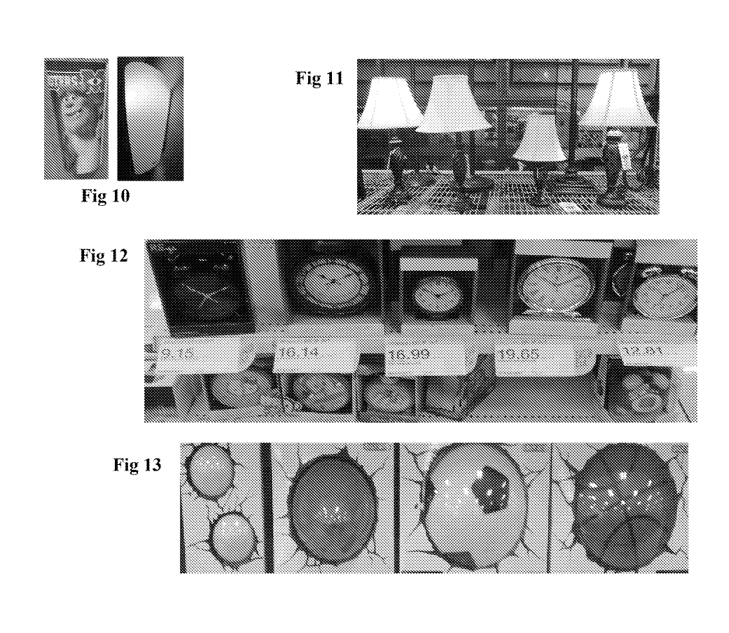

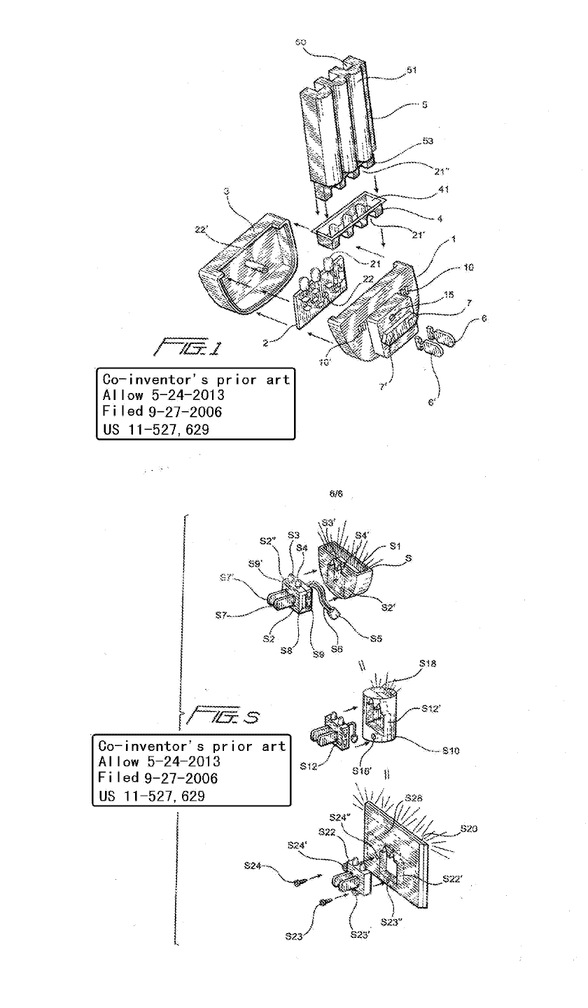

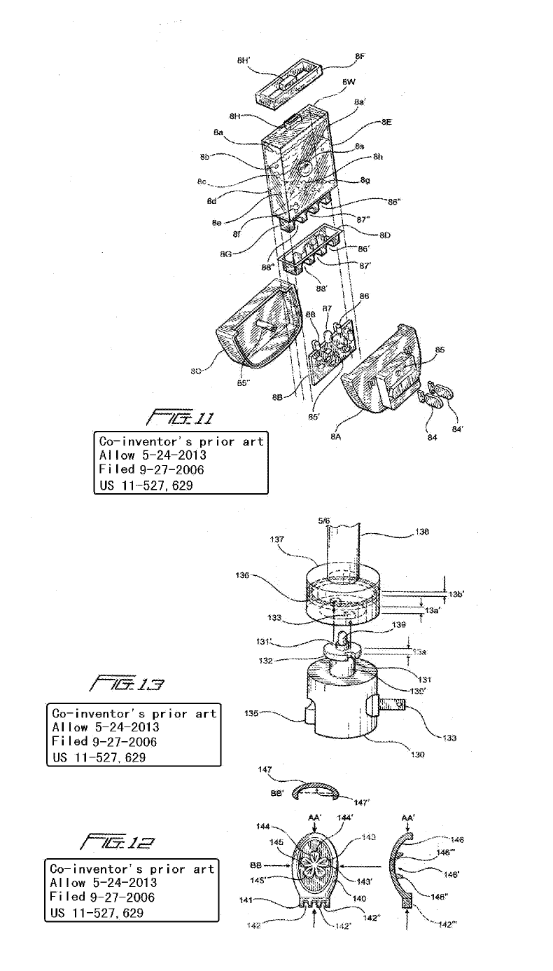

FIGS. 9 and 10, The display unit (90) (100) has plurality of cutouts areas (91) (101) to form a multiple level of the round circle design (91) (101) and 3 display input-ends (92) (102).

From FIG. 12, The alternative display area (140) may has curved egg-shell shape (146) (146′) with negative (146′″) or positive (146″) grave process applied to make the inner surface with 3 dimensional image (144) with sufficient depth (146′″) or height (146″) to make the design, artwork character, drawing, cartoons look alive. The side viewing angle and top viewing angle show the very dedicated feature of current inventions. The said design, artwork, characters, drawing cartoons with hand painting the colors will increase more value appearance than any other market cheap models.

From FIG. 13, The Alternative embodiment disclosure the different concept for the receptacle means (130′) which are build-in on the base (130). From FIG. 13, The said receptacle means (130′) is build-in on the base (130) as one piece which the said receptacle means block out the live wires and components away from people to be touched and match the said display input-end (133) (133′) into the receptacle (131) (13′). The said display input-end (133) (133′) to connect with the receptacle means (131) (131′) to get the light (139), heat (not shown), or desired physical phenomenon from the said base (130) inner electric device (not shown). The said display area (138) has geometric shape with space to load liquid (same as FIG. 11 8E), chemical compound (same as FIG. 11 8E), miniatures (same as FIG. 11 8E), floating staff (same as FIG. 11 8E), reflective piece (same as FIG. 11 8E), variety density liquid (same as FIG. 11 8E), printing background, screen, solid plastic resin with geometric air bubble inside (138), or desired combination of listed items within the said space. The display unit (138) is insert into the hole of input-end (137) with temporary fix which can be separated by pulling, pushing, twisting force to make the display unit to separate from the input-end to make it safety. From FIG. 13, can see the base with LED (139) on top of the receptacle means (132). The two cutouts (131) (131′) to allow the two posts (133) (133′) can passing though the two cutouts (131) (131′) of the ring (132) so the two posts (133) (133′) of the display input-end (137) can push down to lower level of the said ring (132) and twist the display input-end housing (137) to make the two post (133) (133′) to be hold and tighten by the location of ring (132) where without the cutouts (131) (131′). This is the alternative embodiment which have equivalent of the function with the FIG. 1 and FIG. 11 but with tiny deviation, changes, improvements but still fall within the spirit of the current invention.

It is appreciated that all the above discussed description, embodiment, prior art, co-inventors disclosure is not limited to these discussion. Any of the equivalent function, replacement, alternative process, treatments, experiments, and arrangements still belong and within the scope of the current invention.

From Current invention drawing, Hereafter, Do not listed each parts and accessories because prior art had very clear drawing for details. Hereafter only make brief explaination for features of current invention.

From FIG. 1, Can see the 3 piece of the Display-Unit(s) (51) (51′) (51″) each one has the different optics means treatment maybe in silkscreen, painting, texture, spray on its display area with desired color. The 3 piece of display unit(s) are assembly together by the receptacle means (4) for press tight or physic fitting into the receptacle. The receptacle means (4) has several channels (A) (B) (C) to allow to fit the LEDs. The channel (A) has the opening on the center of top the channel so can position the LED light beam to hit the channel (A) to make the its display unit (51′) for illumination. Same as the Channel B has the right opening to allow light to hit its display-unit (51). The Channel C has the Left opening to allow LED light beam to hit into the display unit (51″).

The each LED may has multiple color unit and install on the PCB on the proper space-means to make the LEDs do not interfere each other to emit light beam into other display-unit(s). The (←->) show the space arrangement for the preferred embodiment. The Space means can be any distance even overlay such as FIG. 5-2 and FIG. 6. All LEDs are on the same position of each display-units, so LEDs are overlay for Top-Middle-Lower position to fit into the Display-unit's input end. However, The each LED even has the space means to make separated or desire arrangement of plurality of LEDs. It still has the light beams come out from the LED 4 sides and the rear end, so the best to stop these light beam emit to other display-units, It is need to make light Block-means which may in solid plastic unit or sheet or sticker with light can not passing though material so can block all the 4 sides and rear end of LED light beam leakage out to emit into other display-unit(s). The space means and block means are fatal for current invention. However, any alternative or equivalent skill, method still fall within the current invention for block out the LED's light beams emit to the other display-unit(s).

The Receptacle means is optional, it offer the factory to save time to has this universal base or holder for different display-unit's design but has same configuration, size, thickness, width, depth of Insert display unit's input-end. However, for cost consideration it can make as the FIG. 1-1 which no any receptacle means to hold the multiple display-units and it just use traditional holes on the display unit and these hole are hold by the post of the holder or housing, or use other market available skill such as fix means, assembly means, hook, catcher, glue, Sonic sealing, rivet, screw to fasten multiple display-unit(s). Again, each LED(s) for the display-unit input end still need proper block means and space means so can make sure LEDs' light beam has accurate emit into the right display-unit.

From FIG. 1 and FIG. 1-1 and all following drawing can see the LED (A) (B) (C) are located on the PCB (2) which has proper space arrangement such as FIG. 1, the LED (A) on the middle position of the PCB and illuminate the display (51′), The LED (B) install on the Right side of the PCB to illuminate the Right Display unit (51). The LED(C) install on the left side of PCB to illuminate the LEFT side of the Display unit (51″). These proper space means help the LEDs to fit on right position and emit light into the display unit though the display area optics treatments to make the eye catching effects.

The PCB has power source input end which can use the desire deliver means to deliver the power from the preferred non-portable power source such as AC wire from home electricity by prong means, USB means from computer or charger or transformer, adaptor, invertor means, Socket and Plug sets to get power from the all kind of energy generator or storage device, So the general can said the non-portable power source can use desire conductive means to deliver the power into the Circuit which may selected from Prong means, Plug and receptacle, AC Wire, USB wire, Conductive means, pig-tail, wire device, conductive piece so can get power into the current invention circuit. The FIG. 1 and FIG. 1-1 has the brief description with details drawing for this concept.

From the non-portable power source deliver the power into the said circuit which has incorporate the Integrate circuit (Hereafter as IC) so can make the LED or LEDs has desired light show to turn on and turn off LED or LEDs for period of time which create functions may in any combination from steady-on, chasing, random, sequential, fade-in and fade-out, pair flashing, changing color, automatically changing color, selected color from colorchanging model and freeze one color or any other LED light functions available from market place.

The LED or LEDs can has more than one piece for the each display unit such as the FIG. 5-3 shown and has brief noted for each display unit's LED arrangement to get the LED light special effects.

From The FIG. 1 and FIG. 1-1 can see the non-potable power source and the prong means, AC wire means, Pigtail means, USB wire means, Batteries means which all good for the current invention because current invention for said all LED light device application which the said

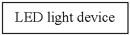

including plug-in night light, table desk LED light, wall mounted LED light, Sign, commercial light box, evacuation sign, advertisement sign, analog time piece, desk top lamp, Clock, light tube, Toy, project light, mobile phone surface panel, communication device, Computer device, consumer electric device as long as these application is not for people portable device and the power can last longer time from the unlimited power source or Energy storage power source or transformer, adaptor, invertor or computer device's USB power all should be fall within the current inventions claims coverage.

From the FIG. 1 show the holder or housing means (1) and (3) which has built-in assembly means of screw (15) to fasten the Receptacle means(4) and PCB means (2) so the housing means will fit all the PCB (2) and receptacle means (4), prong means (6) (6′). It is also the receptacle means to hold the multiple display-unit(s) by physical fitting or other market available skill and method to become a perfect LED light device which can see the Motion/Moving LED light show from the display area with colorful, color changing, moving light, image changeable for any commercial or advertisement or message, or image presentation to viewers. It also can has all kind of cartoon or character's moving exciting light for kids.

From FIG. 1-1 can see there is no any receptacle means to hold the multiple display-units, but it just use the holes on the display-unit and post on the holder or housing means to make the assembly the said PCB and display units and LEDs within the said holder means or housing means. The rest of the parts & accessories same as the FIG. 1.

From FIG. 2 and FIG. 3 show the Multiple display unit(s) (51) (51′) (51″) has its display-unit input-ends which at least one (B) (C) or more than one (A). The each display input-end has opening to allow the LED or LEDs to fit within to allow the LED front light beam can emit into and travel within the each display-unit. And the said each LED has the block means which preferred are metalized plastic sticker so can easily to hold on 4 sides of LED to block out all 4 side has LED light beam leakage out to other display unit. The assembly multiple of display-units (51) (51′) (51″) and fit into the receptacle (41) is one of the design for current invention. The LED has space means (A) (B) (C) on PCB and with sticker block means (A′LED) (B′LED)(C′LED) plus the receptacle (41) has built-in solid plastic resin block means are double protection to make sure all LED light beam will emit into right display unit. This FIG. 2 embodiment has prong means to get power source for plug in type LED light device. The display area for the multiple display units has holiday greeting, seasonal words (Happy New Year) on 1st display-unit (51) and the Starts on the 2^{nd} display unit and Bathlenstars on the 3rd display unit. The built-in IC chip will make the said Happy New Year-→Stars-→Bathlen stars (Chasing or sequential flashing). The color for each display-unit may has printed or spray color or use different color LEDs to make eye-catching exciting light performance, effects, performance.

From FIG. 3. Same as FIG. 2 but the moving message shown (I-→LOVE-→U) for the different color and different shape, different message than the FIG. 2.

From FIG. 5 and FIG. 5-1, FIG. 5-2, FIG. 5-2 and FIG. 6 and FIG. 6-1 has brief notes for the all details concept for current invention for LED color selection and colorful LEDs design for some special effects for each Display unit such as RGB assorted LEDs can get the color changing up to 7 colors show for auto color changing function for individual display unit or for all display units. From FIG. 5 show the 3 different display units has different location of LED for each one of display unit so its circuit shown on FIG. 5-1 is simple to do the space arrangement and block means arrangement. From FIG. 5-2 and FIG. 6 and FIG. 6-1 shown the all LED location of each display unit are at the same relatively position so all LEDs have to overlay on a line and it has to have very good Block means because LEDs on same line (high-middle-low) and have to has top and bottom reflective and adhesive sticker to block out each LED light beams well.

From FIG. 6-1 can see the housing means or holder means which fit all display units and circuit and non-portable power deliver means, switch means, IC means, LEDs, Plurality of display units assembly together. The said holder means or housing means can design for as smaller size as possible or bigger enough to hold or fit all parts & accessories within. The location can be anywhere as long as hide the display unit's input-ends and LEDs and parts & accessories so can pass any safety standard.

From FIG. 7 show the Multiple display-units are position on back side of the space where has the filers so can show out the motion, animation, color changing message, data, screen, logo, Commercial, word, character, cartoon, or any other signals which people can understand for viewers. The LEDs input-ends on the rear parts of receptacle means so LEDs can position right on each of the said display-units to offer the light show with multiple colors and moving light effects, functions, performance from market available IC and models.

From FIG. 7, LED on PCB has proper space means and block means to prevent from the LED light beam emit to wrong display-unit to interfere the light effects.

Non-portable power source which means the LED light device is not for people to wear or bring on the body because the current invention has big power consumer for plurality of LEDs for light show so the this kind of device with portable power source need to replace the batteries very often for the very expensive thin batteries such as CR 2030 or CR2032. So the current invention do not cover the portable LED light device which us such short life and expensive batteries. The battery for current invention should be over the capacity over the 500 ma and cost is cheap such as Carbon battery, Alkline battery which from size of AAA, AA, Sub C, C, or more larger battery for long life, cheap cost application for desk top, Camping, Garden, Festival, Holiday use. It is more appreciated by Green energy such as solar power, Chemical power, Biologic power, food power, or from the computer power which from USB wires means, AC wire means, transformer, adaptor, invertor menas with proper adaptor, plug, receptacle, socket, receiving means such power deliver means to hook with preferred power source.

From FIG. 7, Shown the multiple display units are on the back of the said space so the light show will be passing though the front liquid so can become more splendid and enlarge the image, effects while the LED light shown presented. It also will make the inner at least one filler selected from the group consisting of a liquid, chemical compound, miniature objects, floating, stuff, reflective pieces, liquids of different density, a printed background, a screen, and a combination of said fillers to be glow and be illuminated by the said LEDs from the multiple display-units LED light device. This will increase more light effects while apply to the current FIG. 7 LED light device including for Plug-in device, Battery desk top device, Indoor LED device with preferred non-portable power source as above and below listed categories and LED light device definitions' applications.

From FIG. 4 and FIG. 8 shown the 3 dimension design which has 3 cylinder shape of the display units and each one has the display input-end which can fit with at least one of the LED. From FIG. 8 show the multiple display-units did not limited for flat surface. It can apply to any geometric shape such as curve, cylinder, oval, wave, or any shape can find from geometric theory. It also LED arrangement fo position the each display-unit for cylinder can make the LEDs within the concentric-circle arrangement to put the 1st group of LEDs sit on center, The 2^{nd} group LEDs for 2^{nd} cylinder on 2^{nd} circle, The 3^{rd} group LEDs on the 3^{rd} circle for outer-cylinder display unit. Same as co-inventor's U.S. Pat. No. 7,824,185 FIG. 14 design for concentric-circle arrangement for multiple LEDs to illuminated the cylinder tube for best light effects by more than one LED this concept also same as co-inventor's U.S. Pat. No. 7,455,444 patented concept.

From FIG. 8 also detail of plurality of LEDs arrangement for concentric-circle arrangement for LED (1) for center circle and LEDs (2) 2 pcs for 2^{nd} circle, LEDs (3) 2 pcs for 3^{rd} circuit so can make the cylinder glows with very good light effects without dark area. This is under co-inventors U.S. Pat. No. 7,824,185 FIG. 14 drawing.

From the FIG. 8 show the power source selection has variety choice depend on market requirement for which kind of LED light device to add the said Multiple display-units has special light effects.

From FIG. 9, show the curve surface or it should be said for 3 Dimensional surface with craving or engraving or laser cave process to get 3D image or message or photos within the said display unit with preferred LEDs colorful or auto changing colors functions to glow the inner message, logo, art, design, painting, optics means, color, drawing, cartoon, character, seasonal, religion things can add on the said display units. It also can add any 3 dimensional crave, engraving, laser skill to make the surface or inner space or outside surface. The said multiple display-units are assembly by screw or sonic or glue.

FIG. 10 shown the desired wall lamp applications.

FIG. 11 shown the desk top lamp with shaped has built-in multiple display units within the shade which may made by plastic shade or glass or any light passing though material shade or base or stem.

FIG. 12. Show the time piece application for wall mounted or desk top for analog time piece dial face with Built-in multiple display-units for variety message, image, cartoon, Character presentation for consumer.

FIG. 13 show the wall mounted lamp for light. It also good for tap light for desk top or any sphere or ball surface which can use Plastic or Blister has certain thickness to print out the logo, design, arts on the surface and put multiple display units overlay to form the exciting LED light show tap light or wall light which has the sphere or ball or 3 dimensional LED light device.

From Old Prior art drawing Fig(Prior Arts) FIG. 1+11+12+13+S: Disclosure the co-pending filing U.S. Ser. No. 11/527,629 which filed on Sep. 27, 2006 and got allowance on May 24, 2013 to comparison for current invention drawing which just simple had plurality of display-units and each display-unit has its own LED(s) to make desire colorful, light effects and control by IC and circuit to make the different display-unit(s) has motion for color, image, message, logo, word, screen changeable to get eye-catching purpose to all viewers. Fig S: Disclosure the sealed-unit with LEDs construction to fix on the LED device with details description so this is universal model can fit to all kind of night light device.

It is appreciated that all the above discussed description, embodiment, prior art, co-inventors disclosure is not limited to these discussion. Any of the equivalent function, replacement, alternative process, treatments, experiments, and arrangements still belong and within the scope of the current invention.

1. An Multiple Display-unit LED light device has special Light effects including
a LED light device has at least more than one of display-units, comprising:
More than one display-units each having a different treatment on the said display area and a display input end through which LED(s) light is transmitted to said display area, each display input end of each of said different display units being arranged to be received in a holder or housing means, said holder or housing means having at least one prong means or other electric power signal deliver means for connecting with a non-portable power source and one optional receptacle means or fix means or assembly means for receiving the display input ends of said more than one different display units install or arrange within the said holder or housing means.
at least one LED connected by circuitry to a control means or/and Integrated circuit (I.C.) means and the prong means or electric signal deliver means, to cause the LED(s) to turn on and turn off for a period of time and to exhibit predetermined illumination effects of the said individual display-unit or all display-units selected from the group consisting of flashing, steady-on, chasing, random flashing, pair flashing, color changing, auto color changing, selected color and freeze the color effects of each individual display-unit or/and all display-units, wherein:
At least one LED install within the said the optional the said receptacle mean or holder or housing means by fix means or assembly means to supply the Light beam into the said display areas of the each of the display unit.
the display input end includes means for receiving said at least one LED when said display input end is inserted into said receptacle means or fixed on the holder or housing means, and for transmitting LED(s) light to the respective display area of each different display unit from the LED(s) connect with PCB and each LED(s) are proper has light block means and space-means to block out the LED(s) light beam to emit into wrong display-unit(s) to make a wrong LED light show, function, effects, performance.
at least one of the geometric shape display units is a single piece, and the display area of the at least one of the display units further has a predetermined design selected from the group consisting of art, drawing, design, geometric shape, cartoon, Character, sign, painting, window(s), silkscreen, heat Transfer art, openings, window(s), cut-outs, optics means, LCD screen, digital data, message, words, religion signal, advertisement, warning sign, commercial data, colors, texture, optics treatment, holiday message, Festival message, Seasonal message and holes on its surface or within the unit to provide desired lighting effects and performance, installation on the said holder or housing means and
said receptacle means or holder or housing means is arranged to receive all display units' input ends with right dimensions and configuration and construction of said all display input ends to thereby enable said all display units to be well assembled and connected to said holder or housing without risk of said person touching said parts that carry electricity.
The said 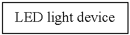
including plug-in night light, table desk LED light, wall mounted LED light, Sign, commercial light box, evacuation sign, advertisement sign, analog time piece, desk top lamp, Clock, light tube, Toy, project light, mobile phone surface panel, communication device, Computer device, suction cup LED battery light for all surface including window type, Christmas tree light with battery or pigtail wire, USB light device, consumer electric device as long as these application is not for people portable device and the power can last longer time from the unlimited power source or Energy storage power source or transformer, adaptor, invertor or computer device's USB power all should be fall within the current inventions claims coverage.

2. An Multiple Display-unit LED light device has special Light effects including
a LED light device has at least more than one of display-units, comprising:
More than one display-units each having a different treatment on the said display area and a display input end through which LED(s) light is transmitted to said display area, each display input end of each of said different display units being arranged to be received in a holder or housing means, said holder or housing means having at least one prong means or other electric power signal deliver means for connecting with a non-portable power source and one optional receptacle means or fix means or assembly means for receiving the display input ends of said more than one different display units install or arrange within the said holder or housing means.
at least one LED connected by circuitry to a control means and Integrated circuit (I.C.) means and the prong means or electric signal deliver means, to cause the LED(s) to turn on and turn off for a period of time and to exhibit predetermined illumination effects of the said individual display-unit or all display-units selected from the group consisting of flashing, steady-on, chasing, random flashing, pair flashing, color changing, auto color changing, selected color and freeze the color effects of each individual display-unit or/and all display-units, wherein:
At least one LED install within the said optional receptacle mean or holder or housing means by fix means or assembly means to supply the Light beam into the said display areas of the each of the display unit.
the display area of at least one of the display units includes a space for at least one filler selected from the group consisting of a liquid, chemical compound, miniature objects, floating, stuff, reflective pieces, liquids of different density, a printed background, a screen, and a combination of said fillers, and
the display input end includes means for receiving said at least one LED when said display input end is inserted into said receptacle means or fixed on the holder or housing means, and for transmitting LED(s) light to the respective display area of each different display unit from the LED(s) connect with PCB and each LED(s) are proper has light block means and space-means to block out the LED(s) light beam to emit into wrong display-unit(s) to make a wrong LED light show, function, effects, performance.
At least one of the geometric shape display units is a single piece install on the said space, and the display area of the at least one of the display units further has a predetermined design selected from the group consisting of art, drawing, design, geometric shape, cartoon, Character, sign, painting, window(s), silkscreen, heat Transfer art, openings, window(s), cut-outs, optics means, LCD screen, digital data, message, words, religion signal, advertisement, warning sign, commercial data, colors, texture, optics treatment, holiday message, Festival message, Seasonal message and holes on its surface or within the unit to provide desired lighting effects and performance, installation on the said holder or housing means and
said receptacle means or holder or housing means is arranged to receive all display units' input ends with right dimensions and configuration and construction of said all display input ends to thereby enable said all display units to be well assembled and connected to said holder or housing without risk of said person touching said parts that carry electricity.
The said 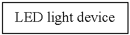
including plug-in night light, table desk LED light, wall mounted LED light, Sign, commercial light box, evacuation sign, advertisement sign, analog time piece, desk top lamp, Clock, light tube, Toy, project light, mobile phone surface panel, communication device, Computer device, suction cup LED battery light for all surface including window type, Christmas tree light with battery or pigtail wire, USB light device, consumer electric device as long as these application is not for people portable device and the power can last longer time from the unlimited power source or Energy storage power source or transformer, adaptor, invertor or computer device's USB power all should be fall within the current inventions claims coverage.

3. An Multiple Display-unit LED light device has special Light effects including
a LED light device has at least more than one of display-units, comprising:
More than one display-units each having a different treatment on the said display area and a display input end through which LED(s) light is transmitted to said display area, each display input end of each of said different display units being arranged to be received in a holder or housing means, said holder or housing means having at least one prong means or other electric power signal deliver means for connecting with a non-portable power source and one optional receptacle means or fix means or assembly means for receiving the display input ends of said more than one different display units install or arrange within the said holder or housing means.
at least one LED connected by circuitry to a control means or/and Integrated circuit (I.C.) means and the prong means or electric signal deliver means, to cause the LED(s) to turn on and turn off for a period of time and to exhibit predetermined illumination effects of the said individual display-unit or all display-units selected from the group consisting of flashing, steady-on, chasing, random flashing, pair flashing, color changing, auto color changing, selected color and freeze the color effects of each individual display-unit or/and all display-units, wherein:
At least one LED install within the said option receptacle mean or holder or housing means by fix means or assembly means to supply the Light beam into the said display areas of the each of the display unit.
the display area of at least one of the display units has a geometric shape, or curved I shape or 2 dimensional or 3 dimension shape with craving, engraving, laser craving, 3D image within the plastic resin, or bubbles within solid plastic resin to provide a three-dimensional image, effect and enable designs, artwork, characters, drawings, and cartoons to appear more lifelike, and
the display input end includes means for receiving said at least one LED when said display input end is inserted into said receptacle means or fixed on the holder or housing means, and for transmitting LED(s) light to the respective display area of each different display unit from the LED(s) connect with PCB and each LED(s) are proper has light block means and space-means to block out the LED(s) light beam to emit into wrong display-unit(s) to make a wrong LED light show, function, effects, performance.
at least one of the geometric shape display units is a single piece, and the display area of the at least one of the display units further has a predetermined design selected from the group consisting of art, drawing, design, geometric shape, cartoon, Character, sign, painting, window(s), silkscreen, heat Transfer art, openings, window(s), cut-outs, optics means, LCD screen, digital data, message, words, religion signal, advertisement, warning sign, commercial data, colors, texture, optics treatment, holiday message, Festival message, Seasonal message and holes on its surface or within the unit to provide desired lighting effects and performance, installation on the said holder or housing means and
said receptacle means or holder or housing means is arranged to receive all display units' input ends with right dimensions and configuration and construction of said all display input ends to thereby enable said all display units to be well assembled and connected to said holder or housing without risk of said person touching said parts that carry electricity.
The said LED light device including plug-in night light, table desk LED light, wall mounted LED light, Sign, commercial light box, evacuation sign, advertisement sign, analog time piece, desk top lamp, Clock, light tube, Toy, project light, mobile phone surface panel, communication device, Computer device, suction cup LED battery light for all surface including window type, Christmas tree light with battery or pigtail wire, USB light device, consumer electric device as long as these application is not for people portable device and the power can last longer time from the unlimited power source or Energy storage power source or transformer, adaptor, invertor or computer device's USB power all should be fall within the current inventions claims coverage.

4. An Multiple Display-unit LED light device has special Light effects including
a LED light device has at least more than one of display-units, comprising:
More than one display-units each having a different treatment on the said display area and a display input end through which LED(s) light is transmitted to said display area, each display input end of each of said different display units being arranged to be received in a holder or housing means, said holder or housing means having at least one prong means or other electric power signal deliver means for connecting with a non-portable power source and one optional receptacle means or fix means or assembly means for receiving the display input ends of said more than one different display units install or arrange within the said holder or housing means.
at least one LED connected by circuitry to a control means or/and Integrated circuit (I.C.) means and the prong means or electric signal deliver means, to cause the LED(s) to turn on and turn off for a period of time and to exhibit predetermined illumination effects of the said individual display-unit or all display-units selected from the group consisting of flashing, steady-on, chasing, random flashing, pair flashing, color changing, auto color changing, selected color and freeze the color effects of each individual display-unit or/and all display-units, wherein:
At least one LED install within the said optional receptacle mean or holder or housing means by fix means or assembly means to supply the Light beam into the said display areas of the each of the display unit.
the display input end includes means for receiving said at least one LED when said display input end is inserted into said receptacle means or fixed on the holder or housing means, and for transmitting LED(s) light to the respective display area of each different display unit from the LED(s) connect with PCB and each LED(s) are proper has light block means and space-means to block out the LED(s) light beam to emit into wrong display-unit(s) to make a wrong LED light show, function, effects, performance.
the display area of at least one of the display units has a geometric shape with space for at least one filler selected from the group consisting of a liquid, chemical compound, miniature objects, floating stuff, reflective pieces, liquids of different density, a printed background, a screen, a solid plastic resin with an air bubble inside, and a combination of said fillers, and
at least one of the geometric shape display units is a single piece, and the display area of the at least one of the display units further has a predetermined design selected from the group consisting of art, drawing, design, geometric shape, cartoon, Character, sign, painting, window(s), silkscreen, heat Transfer art, openings, window(s), cut-outs, optics means, LCD screen, digital data, message, words, religion signal, advertisement, warning sign, commercial data, colors, texture, optics treatment, holiday message, Festival message, Seasonal message and holes on its surface or within the unit to provide desired lighting effects and performance, installation on the said holder or housing means and
said receptacle means or holder or housing means is arranged to receive all display units' input ends with right dimensions and configuration and construction of said all display input ends to thereby enable said all display units to be well assembled and connected to said holder or housing without risk of said person touching said parts that carry electricity.
The said 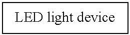
including plug-in night light, table desk LED light, wall mounted LED light, Sign, commercial light box, evacuation sign, advertisement sign, analog time piece, desk top lamp, Clock, light tube, Toy, project light, mobile phone surface panel, communication device, Computer device, suction cup LED battery light for all surface including window type, Christmas tree light with battery or pigtail wire, USB light device, consumer electric device as long as these application is not for people portable device and the power can last longer time from the unlimited power source or Energy storage power source or transformer, adaptor, invertor or computer device's USB power all should be fall within the current inventions claims coverage.

5. An Multiple Display-unit LED light device has special Light effects consist of;
More than one of display-unit(s) has input-end to allow install LED within and said Display-units and LEDs are well install within the holder, or receptacle means or housing means by hole & post, screw, sonic sealing, catcher, press tight or equivalent skill or method from market available.
Each of the LED to fit within the display-unit input-end has its light block-means and install by space means so can prevent from each LED light beam emit into wrong display-unit.
The each LED has connect with circuit means and IC means and connect with non-portable power source by power deliver means which may selected from group combination of prong means, conductive wire, USB means, energy storage means, batteries, AC wire means, solar power, wind power, chemical power, biologic power means, transformer means, adaptor means, invertor means which supply the current.
The each display unit incorporate with IC means to get the light effects which may in desire combination of steady on, flashing, random, fade in and fade out, random flashing, pair flashing, color mixer, auto changing color, color selected and freeze the said function for the individual or all said of the display unit(s).
The each display unit has its display areas which has geometric art, shape, painting, logo, words, sign, message, image, screen, display, evacuation sign, direction, time, optics means, optical treatment, holiday signal, seasonal drawing, commercial or advertisement message or data within the said display area so can incorporate with said LED(s) for predetermined light show, message presentation, commercial promotion, or pass image, message, data to viewers.
The each display unit has work with switch means, photos sensor means, sensor means, motion sensor means, remote control means, blue tooth means to turn on and turn off the LED light device under predetermined timing, duration, period of time.
AT least one holder or housing means to well install the above listed parts & accessories to make a perfect LED light device for any surface installation not including for person wearing purpose.
The said LED light device has application for indoor, outdoor, festival, show time, suction cup LED battery light for all surface including window type, Christmas tree light with battery or pigtail wire, USB light kits, use which is not for portable power source to let people carry on the body.

6. An Multiple Display-unit LED light device has special Light effects as claim 1, The said 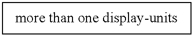
and each display-unit has its own art, design, character, word, logo, sign, geometric shape, color, painting, silkscreen, optics means, light passing through means, semi-transparent means, block-out means, transparent means, plastic resin, Air Bubble, cut outs, opening, windows, colors, characters, cartoon figure, holiday art, seasonal signals, greeting words, commercial advertisement, promotion words, time, digital data display, LCD display screen, Monitor screen, sign or any people understand message on the each display-unit for LED light means to be seen by viewers.

7. The Mutiple Display-units LED light device has special light effects as claim 1, The said has at least one of the 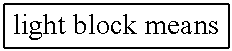
for desire material in preferred shape, construction, design to block out the each LED light beams to interfere or emit into other display-unit to make the light beams in a mess which preferred use metalized sheet. piece, unit in plastic, paper, wooden or other material as long as the LED light beam can not passing though the said block-means to interfere the other display-unit(s) illumination.

8. The Mutiple Display-units LED light device has special light effects as claim 1, The said has 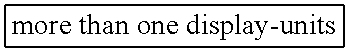
and each display-unit has its own art, design, character, word, logo, sign, geometric shape, color, painting, silkscreen, optics means, light passing through means, semi-transparent means, block-out means, transparent means, plastic resin, Air Bubble, cut outs, opening, windows, colors, characters, cartoon figure, holiday art, seasonal signals, greeting words, commercial advertisement, promotion words, time, digital data display, LCD display screen, Monitor screen, sign or any people understand message on the each display-unit for LED light means to be seen by viewers.

9. The Mutiple Display-units LED light device has special light effects as claim 1, The said has at least one of the 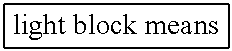
for desire material in preferred shape, construction, design to block out the each LED light beams to interfere or emit into other display-unit to make the light beams in a mess which preferred use metalized sheet. piece, unit in plastic, paper, wooden or other material as long as the LED light beam can not passing though the said block-means to interfere the other display-unit(s) illumination.

10. The Mutiple Display-units LED light device has special light effects as claim 1, The said has at least one of 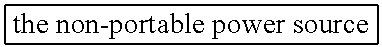
which is not for people to portable to walking because it drain big electric from the batteries, so the current invention for the 1. Plug-in by prong means get the home electricity or 2. The power from the USB port, Computer, Lap top, transformer, adaptor, invertor, charger, USB Charger, solar power, chemical power for any surface installation including desk top, table, wall, floor for indoor or outdoor use. 3. Specially for the Holiday or seasonal or festival for outdoor activities application which can has all art, design, drawing, painting, 3D-engraving, cartoon, character, religion sign, . . . etc. to make the exciting LED light effects, function, performance for color changing, motion, moving message, image, signal to be seen by viewer.

11. The Mutiple Display-units LED light device has special light effects as claim 1, The said has at least one of the 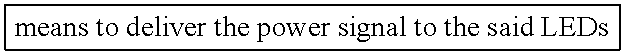
which may selected from group combination such as co-inventor's U.S. Pat. No. 8,303,150 can from the prong means, socket means, AC outlets means, pig-tail wire sets, adaptor plug, plug and receptacle means, socket means, quickly connector means, plug and socket means, USB plug and port means, or any other electric signal delivery means available from market place.

12. The Mutiple Display-units LED light device has special light effects, as claim 1, the said 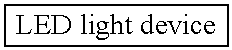
including plug-in night light, table desk LED light, wall mounted LED light, Sign, commercial light box, evacuation sign, advertisement sign, analog time piece, desk top lamp, Clock, light tube, Toy, project light, mobile phone surface panel, communication device, Computer device, consumer electric device as long as these application is not for people portable device and the power can last longer time from the unlimited power source or Energy storage power source or transformer, adaptor, invertor or computer device's USB power all should be fall within the current inventions claims coverage.

13. The Mutiple Display-units LED light device has special light effects as claim 1, The said has at least one 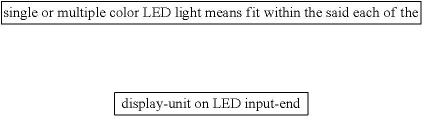
to make the light passing though the said optic-means and show out the art, words, geometric shape, message, data, digital data display, LED display screen, Monitor screen as above listed on (1) to be illuminated to be seen by viewers.

14. The Mutiple Display-units LED light device has special light effects as claim 1, The said has at least 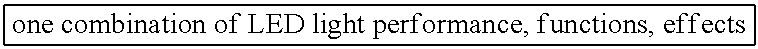
are apply to these said more than one display-units which may selected in desire group from steady-on, flash, sequential, chasing, raondom, fade-in and fade-out, pair flash, desired combination of multiple pair flash to make each of the said display-unit has illumination under pre-determined arrangement.

15. The Mutiple Display-units LED light device has special light effects as claim 1, The said has at least one 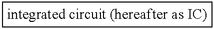
incorporate with the said LED light means to make the light show as above (3) for desire light show not only for each display-unit but also for all display-units has good light show.

16. The Mutiple Display-units LED light device has special light effects as claim 1, The said has at least one of the 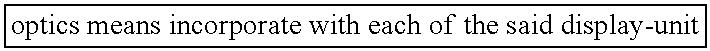
which may selected from light passing though means, light reflective means, light deviation means, retro-reflect means, light refraction means, interface means, convex lens means, concave lens means. forcus means, superposition and interference means, diffraction means, optical resolution means, dispersion means, scattering means, polarization means so can create more eye-catching light effects while apply desired optics means for current inventions.

17. The Mutiple Display-units LED light device has special light effects as claim 1, The said has at least one of the said 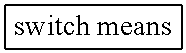
to turn on and turn off the said LED device which may selected from group combination from sensor means, remote control means, magnetic means, motion sensor means, timer means, heater means, moisture means, flood means, photo sensor means, blue tooth means, sound activate switch, wifi signal, internet signal, transmitter and receiver means.

18. The Mutiple Display-units LED light device has special light effects as claim 1, The said has at least one 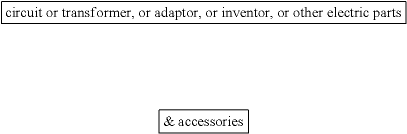
which can change any power source electric signal to work for the said IC means and LED related parts & accessories.

19. The Mutiple Display-units LED light device has special light effects as claim 1, The said has at least one of the 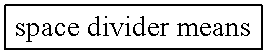
to keep each display-unit's LED has proper space between each other on the horizon or vertical or any axis of the 3 dimensional to make the each display-unit's LED light beams will not interfere or disturb or emit into other display-unit.

20. The Mutiple Display-units LED light device has special light effects, as claim 1, The said 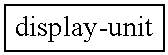
is curve shape, or any geometric shape unit which has 2 or 3 Dimensional with caving, engraving, painting, laser engraving, laser caving to has the 2 or 3 Dimension image can be seen by viewers.

21. The Mutiple Display-units LED light device has special light effects as claim 1, The said display-units includes a space for at least one filler selected from the group consisting of a liquid, chemical compound, miniature objects, floating, stuff, reflective pieces, liquids of different density, a printed background, a screen, and any combination of said fillers.

22. The Mutiple Display-units LED light device has special light effects as claim 1, The said has at least one of the 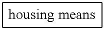
to arrange all the said parts & accessories may selected from group combination of the fasten means, assembly means, catcher means, hold means, fix means, screws means, ultrasonic sealing means, multiple display-units, IC means, switch means, LED related parts & accessories, hosing means, prong means. circuit means, conductive means, prong means, transformer means, adaptor means, socket means, receptacle means, receiving-end, PCB, sensor means, Photo sensor means, remote control means, receiver means, blue tooth means or any other related means to make the said Multiple display-units LED light device has special light effects can work properly put within the said housing.

23. The Mutiple Display-units LED light device has special light effects as claim 1, The said Non-portable power source which means the LED light device is not for people to wear or bring on the body because the current invention has big power consumer for plurality of LEDs for light show so the this kind of device with portable power source need to replace the batteries very often for the very expensive thin batteries such as CR 2030 or CR2032. So the current invention do not cover the portable LED light device which us such short life and expensive batteries. The battery for current invention should be over the capacity over the 500 ma and cost is cheap such as Carbon battery, Alkline battery which from size of AAA, AA, Sub C, C, or more larger battery for long life, cheap cost application for desk top, Camping, Garden, Festival, Holiday use. It is more appreciated by Green energy such as solar power, Chemical power, Biologic power, food power, or from the computer power which from USB wires means, AC wire means, transformer, adaptor, invertor menas with proper adaptor, plug, receptacle, socket, receiving means such power deliver means to hook with preferred power source.

24. The Mutiple Display-units LED light device has special light effects as claim 1, The said LED light device is a window LED light has suction cup to install on all wall, surface, window, glass or has USB wires to connect with power source, or has pigtails wire to connect with light string for holiday or seasonal light sets, or has the AC wire to connect with the home electricity, or has the prong means to plug into outlets of power strip/outlets on wall/outlets from generation/outlets from power source.
